(19) United States
(12) Patent Application Publication
(10) Pub. No.: US 2011/0010943 A1
(43) Pub. Date: Jan. 20, 2011

(54) Electric shaver

(75) Inventor: Heikan Izumi, Matsumoto (JP)

Correspondence Address: Quinn Emanuel Urquhart & Sullivan, LLP;Koda/Androlia, 10th Floor, 865 S. Figueroa Street, Los Angeles, CA, 90017, US

(73) Assignee: Izumi Products Company

(21) Appl. No.: 12/804,235

(22) Filed: Jul. 16, 2010

(30) Foreign Application Priority Data
Jul. 17, 2009 (JP) 2009-168503

(51) Int. Cl. B26B 19/00; B26B 19/20; B26B 19/38

(52) U.S. Cl. 30/34.1; 30/43

(57) ABSTRACT

An electric shaver having a reciprocating shaving cutter assembly at the upper end of its shaver body and also a safety razor assembly disposed parallel to the shaving cutter assembly, the reciprocating shaving cutter assembly being disposed in the direction of shaving of the safety razor assembly.

### BACKGROUND OF THE INVENTION

1. Field of the Invention

The present invention relates to an electric shaver in which shaving cutters of a reciprocating-type electric shaver and a safety razor assembly are provided in combination or integrated.

2. Description of the Related Art

There are various types of electric shavers that have been known conventionally. Those shavers, however, generally have problems with an inability to provide a close shave or with lack of providing sufficiently close shaving. Consequently, for some users, the feeling of skin refreshment felt after shaving has been insufficient, leaving the users dissatisfied with their shaving experience.

Japanese Patent Application National Publication (Kohyo) No. 2007-530215 discloses in view of the above circumstances a grooming device in which a safety razor assembly (a “wet” razor blade) and reciprocating-type electric shaving cutters (trimmers) are provided on a common elongated shaver handle.

The device disclosed in this Japanese Patent Application National Publication (Kohyo) No. 2007-530215 permits a user to select use of either a safety razor or a reciprocating-type electric shaver; and in this device, the electric shaving cutters are provided so as to be set to a use position, where only the electric shaving cutters are used, and to a stored position, where only the safety razor can be used. In other words the safety razor and the electric shaving cutters are used interchangeably, depending on the location of the hair to be shaved from the skin. Consequently, if the feeling of skin refreshment felt after shaving with the electric shaving cutters is inadequate, the handle of the grooming device needs to be re-gripped in a different manner so that the safety razor is used to achieve a closer shave to produce a desired pleasant feeling of skin refreshment.

As seen from the above, with the grooming device described above, when the safety razor is used after the use of the electric shaving cutters, it is necessary to change the grip on the handle of the grooming device and further to apply shaving cream, etc., thus making the use more laborious and requiring time. This is inconvenient when the user is, for instance, in a hurry.

### BRIEF SUMMARY OF THE INVENTION

The present invention was made with such circumstances as described above in mind, and it is an object of the present invention to provide an electric shaver that does not require cumbersome operations which involve use of a safety razor assembly after using of the cutters of the electric shaver and that, at the same time, is capable of achieving the desired pleasant feeling of skin refreshment by providing a sufficiently close shave. It is further an object of the present invention to provide an electric shaver that does not require a safety razor assembly to be provided separately.

The above-described objects are accomplished by a unique structure of the present invention for an electric shaver that has a reciprocating shaving cutter assembly at the top end of its shaver body, and in the present invention, the electric shaver further includes a safety razor assembly, the reciprocating shaving cutter assembly and safety razor assembly are provided parallel to each other, and the reciprocating shaving cutter assembly is provided in the direction of shaving (or advancement) of the safety razor assembly.

The safety razor assembly cuts facial hair by being moved in a direction perpendicular to its razor blade(s) (the shaving direction). Since the reciprocating shaving cutter assembly in the present invention is provided parallel to this safety razor assembly in the direction of shaving of the safety razor assembly (in other words, in the direction of movement of the safety razor assembly), when the shaver body during shaving is moved in the direction of shaving of the safety razor assembly, facial hair is first cut by the cutters of the reciprocating shaving cutter assembly and then subsequently the facial hair is cut by the razor blade(s) of the safety razor assembly that is moved to the same spot where the reciprocating shaving cutters have cut the hair. Accordingly, the same location is shaved in two steps by the reciprocating shaving cutter assembly first and then by the safety razor assembly, and it is possible to achieve a closer shave. The pleasant feeling of skin refreshment perceived by the user is, therefore, increased.

Because the safety razor assembly is provided on the electric shaver, the need to use a safety razor assembly separately is eliminated, the number of operations does not increase, the procedure does not become cumbersome, and the shaving time can be shortened. Accordingly, the shaver of the present invention is convenient to operate when the user is, for instance, in a hurry.

In the present invention, the shaving surface of the reciprocating shaving cutter assembly and the shaving surface of the safety razor assembly can be brought into contact with the skin together or simultaneously, in other words, these surfaces can be disposed in a generally common plane (including flat or curved surfaces). Accordingly, shaving by the safety razor assembly can be carried out immediately after shaving by the reciprocating shaving cutter assembly, achieving excellent efficiency. If the cutters of the reciprocating shaving cutter assembly and the razor blade(s) of the safety razor assembly are brought closer together, then the cutters and blades(s) will produce an integral combination which, as a whole, can be thought of and used as a single cutter, making it even easier to use.

In the structure of the present invention, it is preferable that the reciprocating shaving cutter assembly be provided on the front side of the shaver body (for example, on the side where a power switch is installed), and the safety razor assembly be disposed on the back side and above the reciprocating shaving cutter assembly. In addition, the shaving surface of the safety razor assembly can be slanted upwardly and towards the rear. With these arrangements, placing the top portion of the shaver body against the skin and moving the shaver in a up-to-down direction with the front side of the shaver body at an oblique angle relative to the skin can allow both the reciprocating shaving cutter assembly and the safety razor assembly to be moved together with both of them simultaneously maintained in intimate contact with the skin. Thus, the shaver provides excellent operability.

The safety razor assembly can be provided so as to make vertical movement (to move up and down) along the shaver body as well as to be fixed in place during this movement. In this case, one's preferred shaving technique can be selected by setting the safety razor assembly in the uppermost position and shaving the facial hair using only the safety razor assembly or by setting the safety razor assembly in the lowermost position and shaving the facial hair using only the reciprocating shaving cutters. If the safety razor assembly is set at an intermediate position, the reciprocating shaving cutter assembly and the safety razor assembly can be used simultaneously for the shaving. It is thus possible to select the desired shaving mode (based on the joint use of both cutter assemblies).

The cutters of the reciprocating shaving cutter assembly can be coarse shaving cutters. However, they can be finishing shaving cutters. In addition, reciprocating coarse shaving cutters, reciprocating finishing shaving cutters, and a safety razor assembly (or a safety razor blade) can be arranged in successive order from the front side of the shaver body. Further, a single safety razor assembly can be sandwiched between two reciprocating shaving cutter assemblies that are provided on both sides of the safety razor assembly. In this structure, the reciprocating shaving cutter assembly on the front side of the shaver body and the safety razor assembly form the shaving modes of the present invention.

### BRIEF DESCRIPTION OF THE SEVERAL VIEWS OF THE DRAWINGS

FIG. 1A is a perspective view of an electric shaver according to the present invention with its safety razor assembly in a lowermost position, FIG. 1B is a front view thereof, FIG. 1C is a rear view thereof, and FIG. 1D is a right-side view thereof;

FIG. 2A is a perspective view of the electric shaver according to the present invention with its safety razor assembly in an intermediate position, FIG. 2B is a front view thereof, FIG. 2C is a rear view thereof, and FIG. 2D is a right-side view thereof;

FIG. 3A is a perspective view of the electric shaver according to the present invention with its safety razor assembly in an uppermost position, FIG. 3B is a front view thereof, FIG. 3C is a rear view thereof, and FIG. 3D is a right-side view thereof; and

FIG. 4A is a cross-sectional side view of the shaver of the present invention, and FIG. 4B shows the interior of the shaver of the present invention.

### DETAILED DESCRIPTION OF THE INVENTION

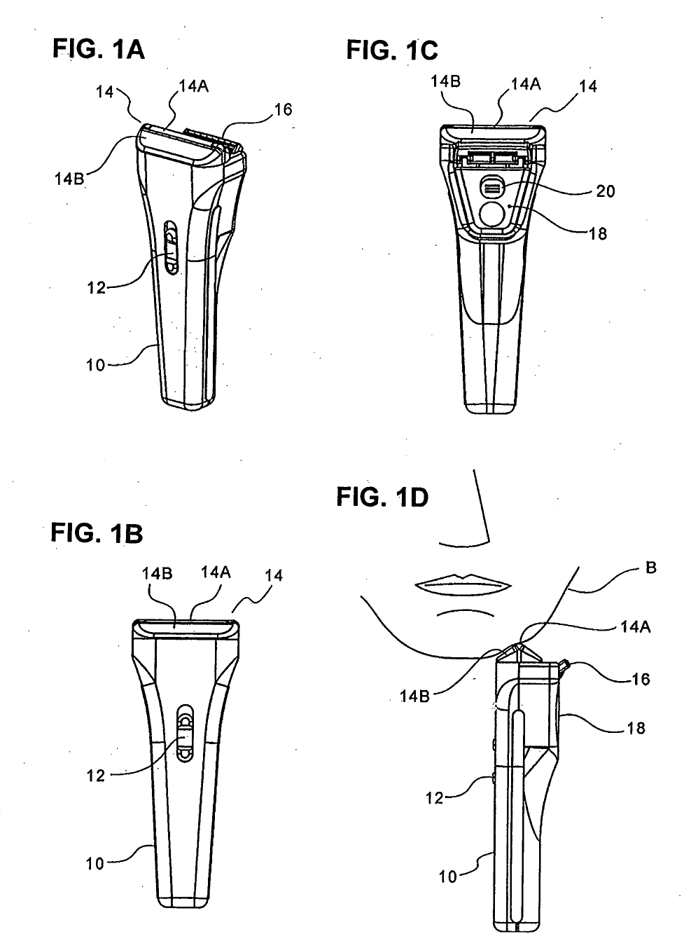

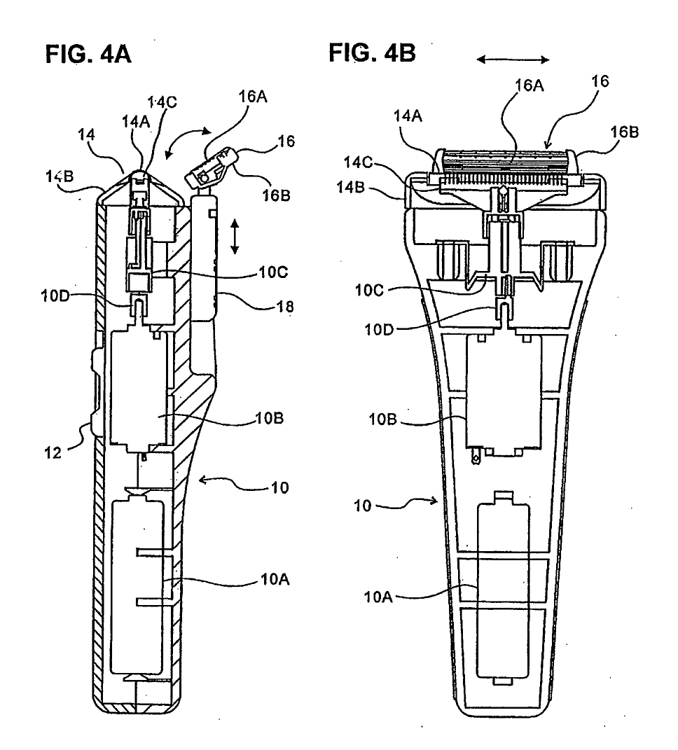

In FIGS. 1A to 4B, the reference numeral 10 designates a shaver body of an electric shaver of the present invention. The shaver body 10 gradually decreases in its diameter towards the bottom portion so as to have a generally tapered shape, and the top portion of the shaver body 10 has a shape that is expanded in the transverse direction and appears generally rectangular when viewed in plane or from above. As shown in FIGS. 4A and 4B, a battery 10A, an electric motor 10B, and an oscillator 10C are, among other parts, housed inside the shaver body 10 in a waterproof fashion. A power switch 12 is provided on the front side of the shaver body 10. The oscillator 10C oscillates from side to side by the action of a cam 10D attached to the rotating shaft of the motor 10B.

A reciprocating shaving cutter assembly 14 is provided on the front side at a top end or the top end of the shaver body 10 and a safety razor assembly 16 is provided on its back side, so that the reciprocating shaving cutter assembly 14 and the safety razor assembly 16 are parallel to their transverse directions. The outer cutter 14A of the reciprocating shaving cutter assembly 14 is formed by perforating multiple small hair apertures in a thin plate curved so as to have a semi-circular shape when viewed from the side and is held on the top edge of the outer cutter case 14B, which is shaped such that its top edge appears pyramidal when viewed from the side (FIG. 4A). The inner cutter 14C of the reciprocating shaving cutter assembly 14 reciprocates from side to side and is accommodated within (or underneath) the outer cutter 14A. The inner cutter 14C is driven to reciprocate from side to side as shown by an arrow in FIG. 4B by the motor 10B and the oscillator 10C housed in the shaver body 10.

The reciprocating shaving cutter assembly 14 is a known finishing shaving cutter. However, it can be a coarse shaving cutter. This is because coarse shaving cutters have a simpler structure and comprise less number of parts. In the present invention, the safety razor assembly 16 serves as a finishing shaving cutter and, therefore, using finishing shaving cutters for the reciprocating shaving cutter assembly 14 allows for an even cleaner finish to be obtained.

The safety razor assembly 16 is provided on the back side of the top portion of the shaver body 10 such that it can be moved or slid up and down along the back side of the shaver body 10 as well as being fixed in place during the vertical movement. More specifically, a movable plate 18 is mounted on the rear face of the top portion of the shaver body 10 so as to be, as shown by a straight arrow in FIG. 4A, vertically slidable or slidable along the rear face of the shaver body 10, and the rear side (bottom side) of the safety razor assembly 16 is provided on this movable plate 18 so that it can pivot back and forth on the top portion of the movable plate 18. A lock button 20 is provided on the back side of the movable plate 18 as shown by a curved arrow in FIG. 4A. The movable plate 18 is manually moved up and down while the lock button 20 is depressed and, when the lock button 20 is released, the movable plate 18 is locked at that position where the button 20 was released. Thus, the safety razor assembly 16 can be set at a desired vertical position on the back of the shaver body 10.

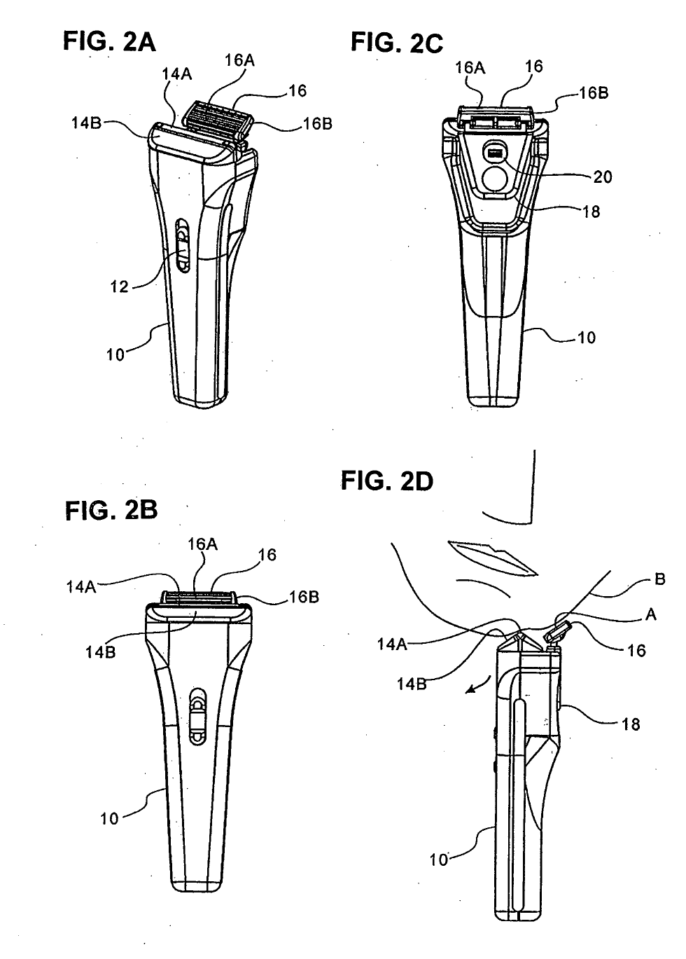

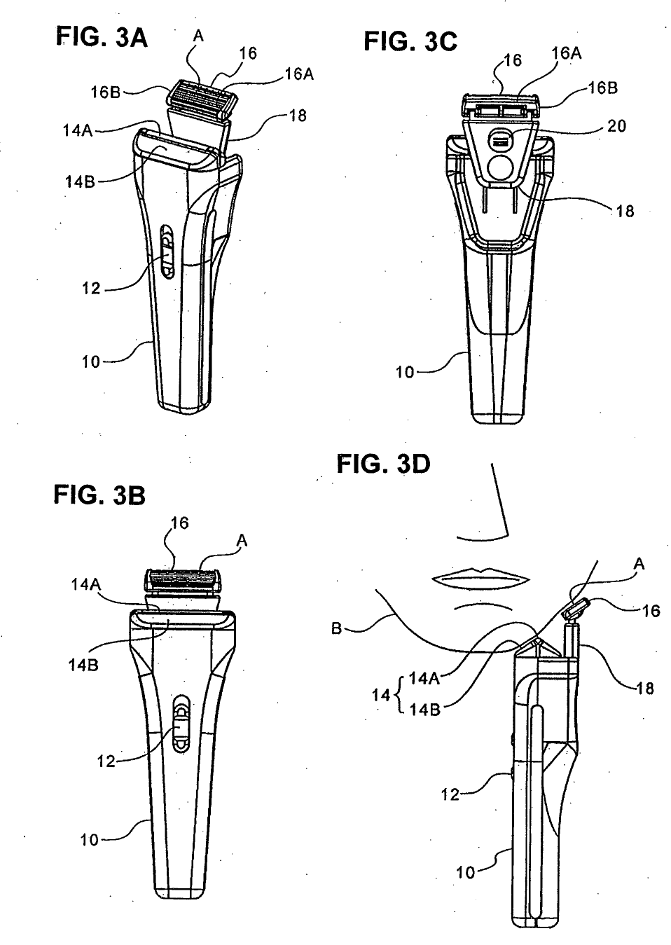

In the safety razor assembly 16, multiple (typically two to five) razor blades 16A are provided in parallel to one another within a razor cartridge 16B, which is referred to as a dual-blade or five-bladed cartridge. The safety razor assembly 16 can have only one razor blade 16A. The razor blades 16A, which are not power-operated unlike the cutter of the reciprocating shaving cutter assembly 14, on the movable plate 18 can be replaced together with the razor cartridge 16b (on a cartridge-by-cartridge basis) with new ones. In the razor cartridge 16B, the shaving surface A of the safety razor assembly 16, i.e. a skin contact surface A (FIGS. 2D and 3D) that comes into contact with the skin, is inclined upwardly and towards the rear (or slanted rearward).

In the state shown in FIGS. 1A through 1C, the safety razor assembly 16 is moved to and fixed in its lowermost position, and the safety razor assembly 16 is lowered below the reciprocating shaving cutter assembly 14. As a result, in this state, as shown in FIG. 1D, only the reciprocating shaving cutter assembly 14 comes into contact with the skin B when the shaver is placed against the skin B of the face, and facial hair is cut only by the cutters of the reciprocating shaving cutter assembly 14.

In the state shown in FIGS. 3A through 3C, the safety razor assembly 16 is moved to and fixed in the uppermost position, and the safety razor assembly 16 protrudes above the reciprocating shaving cutter assembly 14. Accordingly, in this state, as shown in FIG. 3D, only the safety razor assembly 16 comes into contact with the skin B when the shaver is placed against the skin B of the face; and therefore, facial hair is cut only by the blades of the safety razor assembly 16.

When the safety razor assembly 16 is moved to and fixed in the intermediate position shown in FIGS. 2A through 2C, both the reciprocating shaving cutter assembly 14 and the shaving surface A of the safety razor assembly 16 come into contact with the skin B. Accordingly, as shown in FIG. 2D, shaving is performed by the cutters and blades of the reciprocating shaving cutter assembly 14 and safety razor assembly 16 when the reciprocating shaving cutter assembly 14 and the shaving surface A of the safety razor assembly 16 are moved downwardly while being in contact with the skin B. In other words, fine shaving by the safety razor assembly 16 is carried out after shaving by the reciprocating shaving cutter assembly 14 is done.

1. An electric shaver having a reciprocating shaving cutter assembly at a top end of its shaver body, wherein:
said electric shaver further comprises a safety razor assembly provided in parallel to the reciprocating shaving cutter assembly, and
said reciprocating shaving cutter assembly is provided in a direction of shaving of said safety razor assembly.

2. The electric shaver according to claim 1, wherein a shaving surface of the reciprocating shaving cutter assembly and a shaving surface of the safety razor assembly are disposed such that they both come into contact with a skin.

3. The electric shaver according to claim 1, wherein the reciprocating shaving cutter assembly is disposed on a front side of the shaver body of said shaver body, and the safety razor assembly is disposed behind and above the reciprocating shaving cutter assembly.

4. The electric shaver according to claim 1, wherein a shaving surface of the safety razor assembly is slanted upwardly and towards a rear of said shaver body and the reciprocating shaving cutter assembly is disposed in front of and below the safety razor assembly.

5. The electric shaver according to claim 1, wherein the safety razor assembly is enabled for vertical movement on said shaver body and for being fixed in place.

6. The electric shaver according to claim 5, wherein the safety razor assembly is movable between a lowermost position, which permits shaving only by the reciprocating shaving cutter assembly, and an uppermost position, which permits shaving only by the safety razor assembly.

7. The electric shaver according to claim 1, wherein the reciprocating shaving cutter assembly comprises coarse shaving cutters.
